(19) United States
(12) Patent Application Publication
(10) Pub. No.: US 2026/0231899 A1
(43) Pub. Date: Aug. 13, 2026

(54) VEHICLE CARGO BED KENNEL ASSEMBLY

(71) Applicant: Ford Global Technologies, LLC, Dearborn, MI (US)

(72) Inventors: Joaquin Araya, Huixquilucan (MX); Valeria Vazquez, Mexico City (MX); Andrea Vargas, Jilotzingo (MX); Karla Guemes, Mexico City (MX); Carlos Sanchez Cadena, Atizapán de Zaragoza (MX)

(21) Appl. No.: 19/049,284

(22) Filed: Feb. 10, 2025

(51) Int. Cl. A01K 1/02; B62D 33/02

(52) U.S. Cl. CPC A01K 1/0272; A01K 1/0245; B62D 33/0207

(57) ABSTRACT

A kennel assembly includes a kennel wall that spans from a first sidewall of a vehicle cargo bed to a second sidewall of the vehicle cargo bed. The kennel wall is selectively engageable with the first and second sidewalls at a first position and a second position. A kennel roof is adjustable back and forth between a covering position and a storage position. The kennel roof in the covering position is configured to cover a space between the front wall of the cargo bed and the kennel wall to provide a kennel within the cargo bed. The kennel roof in the storage position is sandwiched between the front wall of the cargo bed and the kennel wall to store the kennel wall and the kennel roof within the cargo bed.

### TECHNICAL FIELD

This disclosure relates generally to a kennel assembly used in a cargo bed of a vehicle and, more particularly, to a kennel assembly that can be transitioned from a kenneling position in the cargo bed to a stowed position in the cargo bed.

### BACKGROUND

Kennels are used to contain and shelter animals, such as dogs and cats. Some kennels are adapted for use within a cargo bed of a vehicle. Such kennels can contain and shelter an animal as the vehicle is operated.

### SUMMARY

In some aspects, the techniques described herein relate to a kennel assembly, including: a kennel wall that spans from a first sidewall of a vehicle cargo bed to a second sidewall of the vehicle cargo bed, the kennel wall selectively engageable with the first and second sidewalls at a first position and a second position, the kennel wall spaced a first distance from a front wall of the cargo bed when in the first position, the kennel wall spaced a second distance from the front wall of the cargo bed when in the second position, the second distance less than the first distance; and a kennel roof adjustable back and forth between a covering position and a storage position, the kennel roof in the covering position configured to cover a space between the front wall of the cargo bed and the kennel wall in the first position to provide a kennel within the cargo bed, the kennel roof in the storage position configured to be sandwiched between the front wall of the cargo bed and the kennel wall in the second position to store the kennel wall and the kennel roof within the cargo bed.

In some aspects, the techniques described herein relate to a kennel assembly, wherein the kennel roof extends from the storage position to the covering position.

In some aspects, the techniques described herein relate to a kennel assembly, wherein the kennel roof is configured to unfold from the storage position to the covering position.

In some aspects, the techniques described herein relate to a kennel assembly, wherein the kennel roof is vertically beneath a rear window of the vehicle when the kennel roof is in the covering position and covering the space between the front wall of the cargo bed and the kennel wall in the first position to provide the kennel.

In some aspects, the techniques described herein relate to a kennel assembly, wherein the kennel roof is vertically recessed beneath respective uppermost edges of the first and second sidewalls the vehicle when the kennel roof is in the covering position and covering the space between the front wall of the cargo bed and the kennel wall in the first position to provide the kennel.

In some aspects, the techniques described herein relate to a kennel assembly, wherein the kennel roof includes a first roof section and a second roof section that move relative to each other when the kennel roof is adjusted between the covering position and the storage position.

In some aspects, the techniques described herein relate to a kennel assembly, wherein the first and second roof sections overlap with each other when the kennel roof is in the covering position and the storage position, the first and second roof sections more overlapped in the storage position than the covering position.

In some aspects, the techniques described herein relate to a kennel assembly, wherein the kennel roof is oriented horizontally when covering the space between the front wall of the cargo bed and the kennel wall in the first position, wherein the kennel roof is oriented vertically when sandwiched between the front wall of the cargo bed and the kennel wall in the second position.

In some aspects, the techniques described herein relate to a kennel assembly, wherein the kennel wall includes a plurality of wall slots.

In some aspects, the techniques described herein relate to a kennel assembly, further including a door that is pivotably secured to the kennel wall.

In some aspects, the techniques described herein relate to a kennel assembly, wherein the door includes a plurality of door slots.

In some aspects, the techniques described herein relate to a kennel assembly, further including a first adjustable clamp foot on a driver side of the kennel wall and a second adjustable clamp foot on a passenger side of the kennel wall, the first adjustable clamp foot securing the kennel wall to the first sidewall when the kennel wall is in the first position and when the kennel wall is in the second position, the second adjustable clamp foot securing the kennel wall to the second sidewall when the kennel wall is in the first position and when the kennel wall is in the second position.

In some aspects, the techniques described herein relate to a kennel assembly, wherein the kennel wall is T-shaped.

In some aspects, the techniques described herein relate to a kennel assembly, wherein the kennel roof and the kennel wall are both a polymer-based material.

In some aspects, the techniques described herein relate to a kennel assembly, wherein the kennel roof and the kennel wall are both a thermoplastic olefin.

In some aspects, the techniques described herein relate to a kennel assembly, further including a cleat adjacent to the kennel wall and secured to a floor of the cargo bed.

In some aspects, the techniques described herein relate to a kennel assembly, wherein the kennel wall is pressure-mounted between the first sidewall and the second sidewall.

In some aspects, the techniques described herein relate to a kennel assembly, including: a kennel wall configured to be pressure-mounted between a first and a second sidewall of a vehicle cargo bed at a first position, and to be pressure-mounted between the first and the second sidewalls at a second position, the kennel wall spaced a first distance from a front wall of the cargo bed when in the first position, the kennel wall spaced a second distance from the front wall of the cargo bed when in the second position, the second distance less than the first distance; and a kennel roof configured to cover a space between the front wall of the cargo bed and the kennel wall in the first position to provide a kennel within the cargo bed.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a perspective view of a cargo bed of a vehicle having a kennel assembly in a kenneling position.

FIG. 2 illustrates a perspective view of the kennel assembly in the kenneling position of FIG. 1.

FIG. 3 illustrates the view of FIG. 1 with the kennel assembly in a stowed position.

FIG. 4 illustrates a perspective view of the kennel assembly in the stowed position of FIG. 3.

### DETAILED DESCRIPTION

This disclosure details an exemplary kennel assembly that, in a kenneling position, can contain and shelter an animal in a cargo area of a vehicle, such as a truck. The animal can be a pet, such as a dog or cat. When the kennel assembly is not needed, the kennel assembly can be transitioned to a stowed position within the cargo bed. The kennel assembly in the stowed position remains with the vehicle so the kennel can be used if needed.

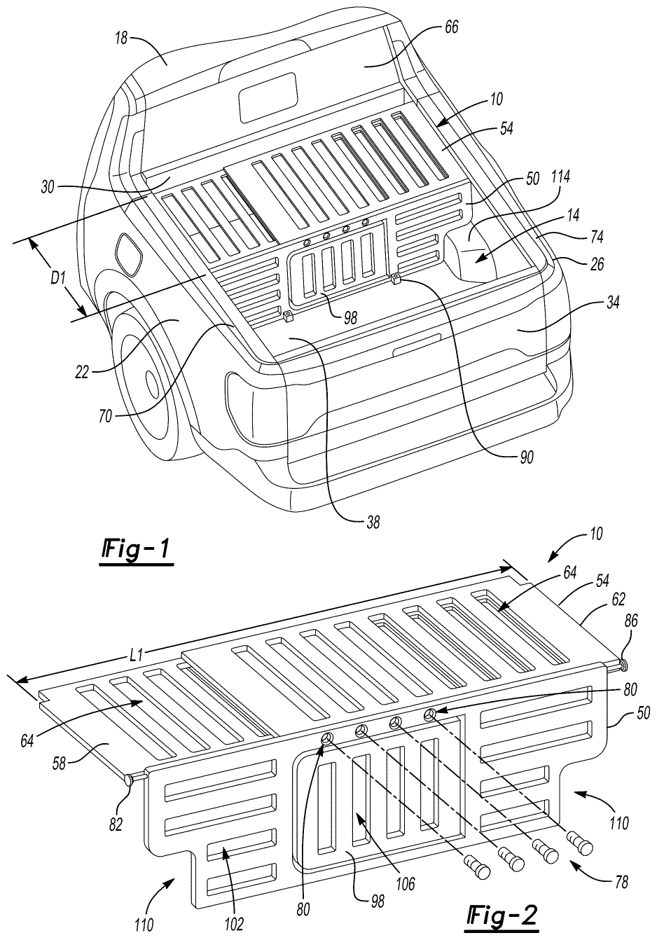

With reference to FIGS. 1-4, a kennel assembly 10 is positioned within a cargo bed 14 of a vehicle 18. In this example, the vehicle 18 is a pickup truck and, more particularly, a unibody pickup truck.

Generally, the cargo bed 14 of the vehicle 18 is established between a first sidewall 22, a second sidewall 26, a front wall 30, and a tailgate 34. In this example, the first sidewall 22 is a driver side sidewall and the second sidewall 26 is a passenger side sidewall. The cargo bed 14 includes a floor 38.

The kennel assembly 10 includes a kennel wall 50 and a kennel roof 54. When the kennel assembly 10 is in a kenneling position shown in FIGS. 1 and 2, the kennel wall 50 spans from the first sidewall 22 to the second sidewall 26, and the kennel roof 54 covers a space between the front wall 30 of the vehicle 18 and the kennel wall 50 of the kennel assembly 10. When the kennel assembly 10 is in the kenneling position, the kennel wall 50 is spaced a first distance D1 from the front wall 30.

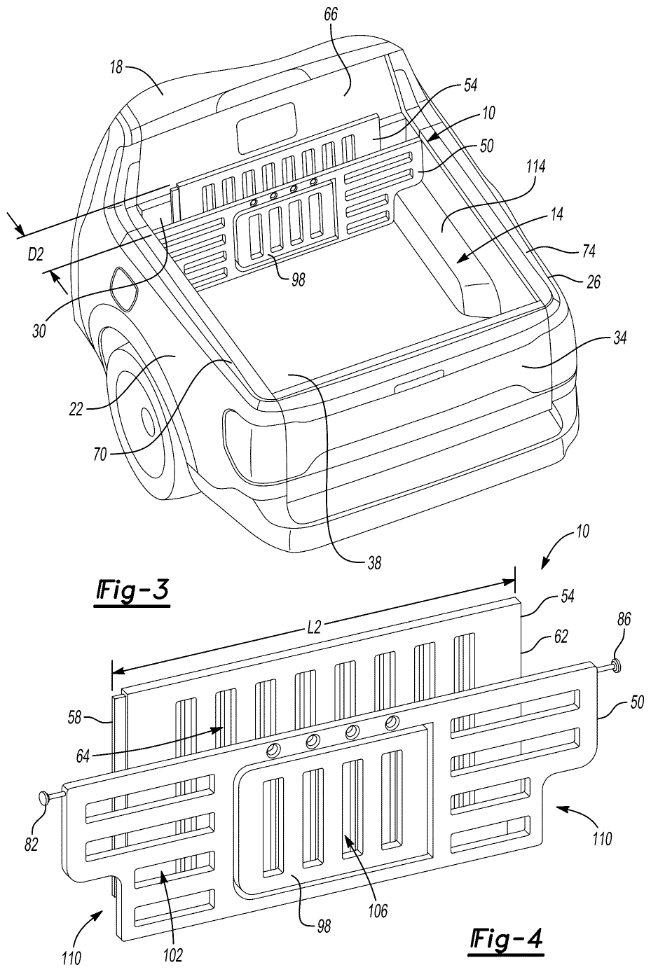

When the kennel assembly 10 is in a stowed position shown in FIGS. 3 and 4, the kennel wall 50 still spans from the first sidewall 22 to the second sidewall 26, but is spaced further forward in the cargo bed 14. When the kennel assembly 10 is in the stowed position, the kennel wall 50 is spaced a second distance D2 from the front wall 30. The second distance D2 is less than the first distance D1. In this example, the second distance D2 is great enough to accommodate the kennel roof 54 when the kennel roof 54 is in the storage position.

The kennel roof 54 is adjustable back-and-forth between a covering position shown in FIGS. 1 and 2, and a storage position shown in FIGS. 3 and 4. The kennel roof 54 is in the covering position when the kennel assembly 10 is in the kenneling position. The kennel roof 54 is in the storage position when the kennel assembly 10 is in the stowed position. The kennel roof 54 is oriented horizontally when in the covering position, and is oriented vertically when in the storage position. Horizontal and vertical are with reference to ground and a general orientation of the vehicle 18.

A length L1 of the kennel roof 54 in the covering position is greater a length L2 of the kennel roof 54 when the kennel roof 54 is in the storage position. That the kennel roof 54 can be adjusted from the length L1 to the length L2 allows the kennel roof 54 to be accommodated between the front wall 30 and the kennel wall 50.

In this example, the kennel roof 54 includes a first roof section 58 and a second roof section 62 that slidably engages with the first roof section 58. The first roof section 58 can include grooves that receive rails of the second roof section 52. The first roof section 58 can then extend and retract relative to the second roof section 52 to adjust the kennel roof 54 back-and-forth between the covering position of FIG. 1 and the storage position of FIG. 2.

To transition the kennel assembly 10 from the kenneling position of FIG. 1 to the storage position of FIG. 2, the kennel roof 54 can be retracted from the extended position to the storage position, and the kennel wall 50 can be moved from the first position to the second position. The kennel roof 54 can then be positioned as shown in FIG. 2 where the kennel roof 54 is sandwiched between the front wall 30 and the kennel wall 50. If the kennel roof 54 were not adjusted to the length L2, the kennel roof 54 would not be able to fit between the first sidewall 22 and the second sidewall 26.

In this example, the first roof section 58 and the second roof section 52 overlap with each other when the kennel roof 54 is in the covering position and when the kennel roof 54 is in the storage position. The first roof section 58 and the second roof section 62 are more overlapped when the kennel roof 54 is in the storage position. The overlapping of the first roof section 58 and the second roof section 62 can reduce an overall packaging size of the kennel roof 54 to facilitate storing the kennel roof 54 within the cargo bed 14.

Although the first roof section 58 and the second roof section 62 extend and retract relative to each other to transition the kennel roof 54 back-and-forth between the storage position and the covering position, the first roof section 58 and the second roof section 62 could transition back and forth between the storage position and the covering position in other ways. For example, the first roof section 58 and the second roof section 62 could instead be pivotably connected to one another. To adjust from the covering position to the storage position, the first roof section 58 and the second roof section 62 could be pivoted and folded against each other, and then unfolded from the storage position back to the covering position.

The first roof section 58 and the second roof section 62 each include elongated openings 64 for ventilation to an interior of the kennel assembly 10. In other examples, the elongated openings 64 could be omitted to provide additional shade or to shield an animal within the kennel assembly 10 from rain.

In this example, when the kennel roof 54 is in the covering position and the kennel assembly 10 is in the kenneling position, the kennel roof 54 is vertically beneath a rear window 66 of the vehicle 18. Keeping the kennel roof 54 beneath the rear window 66 can help to prevent the kennel roof 54 from interfering with visibility through the rear window 66. The kennel roof 54 is also, when in the covering position, vertically recessed beneath an uppermost edge 70 of the first sidewall 22 and an uppermost edge 74 of the second sidewall 26.

The kennel roof 54 and the kennel wall 50 are both made of a polymer-based material in this example. When in the kenneling position, the kennel wall 50 and the kennel roof 54 can be joined together utilizing a plurality of mechanical fasteners 78 that extend, in this example, through apertures 80 in the kennel wall 50 to threadably engage the kennel roof 54.

The kennel wall 50 is secured to the vehicle 18 via, among other things, a first adjustable clamp foot 82 on a driver side of the kennel wall 50 and a second adjustable clamp foot 86 on a passenger side of the kennel wall 50. The adjustable clamp feet 82 and 86 can be rotated to change how far the adjustable clamp feet 82 and 86 extend laterally outward. The adjustable clamp feet 82 and 86 can be rotated to press outward against the respective first sidewall 22 and the second sidewall 26 to hold the position of the kennel wall 50 when the kennel wall 50 is in the first position and when the kennel wall 50 is in the second position. The kennel wall 50 is thus pressure-mounted between the first sidewall 22 and the second sidewall 26. The kennel wall 50 is, in this example, secured to the cargo bed 14 without fastening the kennel wall 50 directly to the vehicle 18. In other examples, the kennel wall 50 could be hooked to the first sidewall 22 and the second sidewall 26.

To further secure the kennel wall 50, at least one cleat 90 can be secured to a floor 38 of the cargo bed 14 adjacent to a lower edge of the kennel wall 50. The cleat 90 can prevent an animal within the kennel assembly 10 from pressing outward against the kennel wall 50 and causing the kennel wall 50 to rotate.

The kennel wall 50 includes a door 98 that is pivotably secured to the kennel wall 50. An animal can enter and exit the kennel assembly 10 through the door 98 when the kennel assembly 10 is in the kenneling position.

The example kennel wall 50 includes a plurality of wall slots 102. The door 98 includes a plurality of door slots 106. The wall slots 102 and the door slots 106 provide ventilation within the kennel assembly 10. In this example, the wall slots 102 are elongated in a horizontal direction and the door slots 106 are elongated in a vertical direction.

The kennel wall 50, when viewed from a rear of the vehicle, is T-shaped with clearance openings 110 at its outboard edges that allow the kennel wall 50 to fit around wheel wells 114 within the first sidewall 22 and the second sidewall 26.

The kennel roof 54 can be fastened directly to the first sidewall 22 and the second sidewall 26 via fasteners. Other mechanisms could be used to fasten the kennel roof 54 in other examples.

In this example, the kennel wall 50 and the kennel roof 54 are both a polymer-based material such as thermoplastic olefin (TPO).

Features of the disclosed examples include a kennel that can be transitioned from a kenneling position to a storage position. A kennel roof can be adjustable back-and-forth between a covering position and storage position. In the storage position, a packaging envelope required by the kennel roof can be reduced to facilitate storage of the roof section and the overall kennel assembly 10.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

1. A kennel assembly, comprising:
a kennel wall that spans from a first sidewall of a vehicle cargo bed to a second sidewall of the vehicle cargo bed, the kennel wall selectively engageable with the first and second sidewalls at a first position and a second position, the kennel wall spaced a first distance from a front wall of the cargo bed when in the first position, the kennel wall spaced a second distance from the front wall of the cargo bed when in the second position, the second distance less than the first distance; and
a kennel roof adjustable back and forth between a covering position and a storage position, the kennel roof in the covering position configured to cover a space between the front wall of the cargo bed and the kennel wall in the first position to provide a kennel within the cargo bed, the kennel roof in the storage position configured to be sandwiched between the front wall of the cargo bed and the kennel wall in the second position to store the kennel wall and the kennel roof within the cargo bed.

2. The kennel assembly of claim 1, wherein the kennel roof extends from the storage position to the covering position.

3. The kennel assembly of claim 1, wherein the kennel roof is configured to unfold from the storage position to the covering position.

4. The kennel assembly of claim 1, wherein the kennel roof is vertically beneath a rear window of the vehicle when the kennel roof is in the covering position and covering the space between the front wall of the cargo bed and the kennel wall in the first position to provide the kennel.

5. The kennel assembly of claim 1, wherein the kennel roof is vertically recessed beneath respective uppermost edges of the first and second sidewalls of the vehicle when the kennel roof is in the covering position and covering the space between the front wall of the cargo bed and the kennel wall in the first position to provide the kennel.

6. A kennel assembly, comprising:
a kennel wall that spans from a first sidewall of a vehicle cargo bed to a second sidewall of the vehicle cargo bed, the kennel wall selectively engageable with the first and second sidewalls at a first position and a second position, the kennel wall spaced a first distance from a front wall of the cargo bed when in the first position, the kennel wall spaced a second distance from the front wall of the cargo bed when in the second position, the second distance less than the first distance; and
a kennel roof adjustable back and forth between a covering position and a storage position, the kennel roof in the covering position configured to cover a space between the front wall of the cargo bed and the kennel wall in the first position to provide a kennel within the cargo bed, the kennel roof in the storage position configured to be sandwiched between the front wall of the cargo bed and the kennel wall in the second position to store the kennel wall and the kennel roof within the cargo bed,
wherein the kennel roof includes a first roof section and a second roof section that move relative to each other when the kennel roof is adjusted between the covering position and the storage position.

7. The kennel assembly of claim 6, wherein the first and second roof sections overlap with each other when the kennel roof is in the covering position and the storage position, the first and second roof sections more overlapped in the storage position than the covering position.

8. The kennel assembly of claim 1, wherein the kennel roof is oriented horizontally when covering the space between the front wall of the cargo bed and the kennel wall in the first position, wherein the kennel roof is oriented vertically when sandwiched between the front wall of the cargo bed and the kennel wall in the second position.

9. The kennel assembly of claim 1, wherein the kennel wall includes a plurality of wall slots.

10. The kennel assembly of claim 9, further comprising a door that is pivotably secured to the kennel wall.

11. The kennel assembly of claim 10, wherein the door includes a plurality of door slots.

12. The kennel assembly of claim 1, further comprising a first adjustable clamp foot on a driver side of the kennel wall and a second adjustable clamp foot on a passenger side of the kennel wall, the first adjustable clamp foot securing the kennel wall to the first sidewall when the kennel wall is in the first position and when the kennel wall is in the second position, the second adjustable clamp foot securing the kennel wall to the second sidewall when the kennel wall is in the first position and when the kennel wall is in the second position.

13. The kennel assembly of claim 1, wherein the kennel wall is T-shaped.

14. The kennel assembly of claim 1, wherein the kennel roof and the kennel wall are both a polymer-based material.

15. The kennel assembly of claim 1, wherein the kennel roof and the kennel wall are both a thermoplastic olefin.

16. The kennel assembly of claim 1, further comprising a cleat adjacent to the kennel wall and secured to a floor of the cargo bed.

17. The kennel assembly of claim 1, wherein the kennel wall is pressure-mounted between the first sidewall and the second sidewall.

18. A kennel assembly, comprising:
a kennel wall configured to be pressure-mounted between a first and a second sidewall of a vehicle cargo bed at a first position, and to be pressure-mounted between the first and the second sidewalls at a second position, the kennel wall spaced a first distance from a front wall of the cargo bed when in the first position, the kennel wall spaced a second distance from the front wall of the cargo bed when in the second position, the second distance less than the first distance; and
a kennel roof configured to cover a space between the front wall of the cargo bed and the kennel wall in the first position to provide a kennel within the cargo bed.
